(19) United States
(12) Patent Application Publication
(10) Pub. No.: US 2002/0096501 A1
(43) Pub. Date: Jul. 25, 2002

(54) Method and apparatus for piercing and thermally processing quartz using laser energy

(76) Inventors: Peter Schultz, Bogart, GA (US); Dmitri Nikiten, Daytona Beach Shores, FL (US); Vladimire Borissovskii, Lake Mary, FL (US); Thomas Michel, Eustis, FL (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/845,887

(22) Filed: Apr. 30, 2001

Related U.S. Application Data
(63) Continuation-in-part of application No. 09/516,937, filed on Mar. 1, 2000.

(51) Int. Cl. B23K 26/38; B23K 26/40; B23K 26/20

(52) U.S. Cl. 219/121.69; 219/121.64; 219/121.62

(57) ABSTRACT

Methods, systems, and apparatus consistent with the present invention use laser energy for thermally processing a quartz object using a beam of laser energy. Once placed in a configuration where the laser beam can be applied to an exterior surface of the quartz object, one or more laser beams are applied to a starting point on the surface. The laser beams may have the same or different wavelengths, energy levels and/or focal lengths. As the surface is heated by the laser energy, the surface is eventually pierced by the beam and a channel forms within the quartz object. As the channel deepens to access an inner portion of the object, the energy of the beam is altered to thermally process or selectively heat the inner portion. After processing the inner portion, the channel is typically closed by fusion welding the walls of the channel (or the channel and quartz filler material) using the beam.

### RELATED APPLICATIONS

This application is a continuation-in-part of U.S. patent application Ser. No. 09/516,937 entitled METHOD APPARATUS AND ARTICLE OF MANUFACTURE FOR DETERMINING AN AMOUNT OF ENERGY NEEDED TO BRING A QUARTZ WORKPIECE TO A FUSION WELDABLE CONDITION, which was filed on Mar. 1, 2000. This application is also related to several concurrently filed and commonly owned patent applications as follows: U.S. patent application Ser. No. ______ entitled “METHOD AND APPARATUS FOR FUSION WELDING QUARTZ USING LASER ENERGY,” U.S. patent application Ser. No. ______ entitled “METHOD AND APPARATUS FOR CREATING A REFRACTIVE GRADIENT IN GLASS USING LASER ENERGY”, U.S. patent application Ser. No. ______ entitled “METHOD AND APPARATUS FOR CONCENTRICALLY FORMING AN OPTICAL PREFORM USING LASER ENERGY”, and U.S. patent application Ser. No. ______ entitled “METHOD AND APPARATUS FOR THERMALLY PROCESSING QUARTZ USING A PLURALITY OF LASER BEAMS.”

### BACKGROUND OF THE INVENTION

A. Field of the Invention

This invention relates to systems for thermally processing glass and, more particularly stated, to systems and methods for using one or more beams of laser energy to pierce, heat and selectively and thermally process a quartz object.

B. Description of the Related Art

One of the most useful industrial glass materials is quartz glass. It is used in a variety of industries: optics, semiconductors, chemicals, communications, architecture, consumer products, computers, and associated industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground, or drawn down to other usable sizes.

Many types of glasses have been “welded” or joined together with varying degrees of success. For many soft, low melting point types of glass, these attempts have been more successful than not. However, for higher temperature compounds, such as quartz, welding has been difficult. Even when welding of such higher temperature compounds is possible, the conventional processes are typically quite expensive and time-consuming due to the manual nature of such processes and the required annealing times.

When attempting to weld quartz, a critical factor is the temperature of the weldable surface at the interface of the quartz workpiece to be welded. The temperature is critical because quartz itself does not go through what is conventionally considered to be a liquid phase transition as do other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically between about 1900 to 1970 degrees Celsius, within which one can optimally fusion weld quartz. In other words, in that usable temperature range, the quartz object will fuse to another quartz object in that their molecules will become intermingled and become a single piece of water clear glass instead of two separate pieces with a joint. However, quartz vaporizes above that temperature range, which essentially destroys part of the quartz workpiece at the weldable surface. Thus, one of the problems in achieving an optimal quartz fusion weld is controlling how much energy is applied so that the quartz workpiece reaches a weldable condition without being vaporized.

Prior attempts to fusion weld quartz have used a hydrogen oxygen flame to apply energy to the weldable surface of the quartz workpiece. Unfortunately, most of the heat energy from the flame is lost, the heat is not uniformly applied, and a wind-tunnel effect is created that blows away sublimated quartz. Additionally, the flame is conventionally applied by hand where the welder repeatedly applies the heat and then attempts to test the plasticity of the quartz workpiece until ready for welding. This process remains problematic because it takes a very long time, wastes energy, usually introduces stresses within the weld requiring additional time for annealing, and does not avoid sublimation of the quartz workpiece.

Another possibility for heating the quartz workpiece to a fusion weldable condition is to use a temperature feedback system. However, attempts to empirically measure the temperature of the quartz workpiece as part of a feedback loop have been found to be unreliable. Physical measurements of temperature undesirably load the quartz workpiece. Those skilled in the art will appreciate that this type of physical measurement also introduces uncertainties that are characteristic with most any physical measurement but especially present in the high temperature state of quartz when near or at a fusion weldable condition.

In addition to simply welding quartz together, there is a need for a method or system that can quickly and easily thermally process an inner portion of a given piece of quartz. If a quartz object, such as a quartz block used to create one of the walls for a large chemical reactor vessel or a preform, has been welded together, the welding joint may not have completely fused leaving an imperfection within the quartz object. One way to fix or thermally process that internal portion of the object is to heat the entire object up in an annealing oven. Unfortunately, this is brute force and an undesirably long process. Furthermore, this may not be desirable if another part of the object has been doped and the additional annealing would cause undesired migration of the dopant material.

Accordingly, there is a need for a system to apply the energy required to bring a quartz workpiece to a fusion weldable condition in a substantially even or uniform fashion, in a time efficient manner, and without sublimating the quartz workpiece or causing stress fractures. Such a system will avoid applying too much energy (which vaporizes the quartz) or applying too little energy (which creates a cold joint requiring an undesirably long annealing process). Furthermore, there is a need for a system that can quickly and efficiently thermally process an inner portion of the quartz without requiring an undesirably long annealing process.

### SUMMARY OF THE INVENTION

Methods, systems, and articles of manufacture consistent with the present invention overcome these shortcomings by using laser energy to thermally process one or more quartz objects. More particularly stated, a method consistent with the present invention, as embodied and broadly described herein, begins with applying a beam of laser energy to the quartz object and then forming a channel within the object from an exterior surface of the object to an inner portion of the object. Once the channel has been formed, the inner portion of the quartz object is thermally processed (e.g., selectively heating, annealing, thermally inducing diffusion within the inner portion, re-welding the inner portion, etc.) before the channel is then closed using the beam of laser energy. Closing of the channel may be accomplished by fusion welding the interior sides of the channel back together and may involve providing a quartz filler rod as filler material within the channel.

In another aspect of the present invention, as embodied and broadly described herein, a method for thermally processing a quartz object begins by piercing the quartz object with a beam of laser energy (such as a laser beam) and then thermally processing an inner portion of the object using the beam (e.g., inducing thermal diffusion within the object at or near the heated inner portion). Thermal processing of the inner portion is preferably implemented by selectively applying the beam to the inner portion for a predetermined amount of time at a predefined energy level. The pierced object is then usually closed by fusion welding the object together using the beam or, more particularly stated, using a fill rod of quartz with the applied laser beam to cause fusion welding of the pierced quartz object and the fill rod quartz.

Piercing the object may be accomplished by applying the beam of laser energy at a first energy level to a starting point on the quartz object. Additionally, thermally processing the inner portion maybe accomplished by applying the beam at a second energy level as the beam reaches the inner portion or is proximately near the inner portion. Typically, the first energy level is more than the second energy level.

In yet another aspect of the present invention, as embodied and broadly described herein, an apparatus for thermally processing a quartz object has a laser energy source capable of applying a beam of laser energy to the object to pierce a surface of the object and then to thermally process an inner portion of the object using the beam. In one embodiment, the beam may be a composite beam having multiple laser beams from multiple lasers within the source. In more detail, the composite beam may have multiple laser beams from multiple laser sources with different wavelengths, energy levels, and focal points. These various beams with their respective wavelengths, energy levels and focal points can be used to selectively process or affect a variety of materials, doping agents, elements, compounds to facilitate altering the characteristics of the materials as well as altering their interaction with the quartz due to their selective sensitivity to different wavelengths of laser energy.

The apparatus may also include a welding head coupled to receive the laser energy from the laser energy source. The welding head operates to direct the laser energy onto a surface of the quartz object. The welding head may be selectively positioned relative to the object's surface or the surface and the laser energy source.

The apparatus may further include a controller in communication with the laser energy source and the movable head. The controller is typically able to cause the laser energy source to provide the beam at a first energy level to the movable head and cause the movable head to be positioned relative to the laser energy source in order to properly apply the beam on the object's surface.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1, consisting of FIGS. 1A-1C, is a series of diagrams illustrating an exemplary quartz laser fusion welding system consistent with an embodiment of the present invention;

FIG. 2 is a diagram illustrating an exemplary movable welding head used to direct laser energy consistent with an embodiment of the present invention;

FIG. 3 is a functional block diagram illustrating components within the exemplary quartz laser fusion welding system consistent with an embodiment of the present invention;

FIG. 4, consisting of FIGS. 4A-4B, is a diagram illustrating a welding zone between quartz objects being laser fusion welded consistent with an embodiment of the present invention;

FIG. 5 is a flow chart illustrating typical steps for fusion welding a first quartz object to a second quartz object consistent with an exemplary embodiment of the present invention;

FIG. 6, consisting of FIGS. 6A-6D, is a diagram illustrating how a laser beam can be used to thermally process an inner portion of a quartz object consistent with an embodiment of the present invention;

FIG. 7 is a flow chart illustrating typical steps for thermally processing a quartz object using laser energy consistent with an embodiment of the present invention; and

FIG. 8 is a diagram illustrating a laser energy source having multiple laser beams consistent with an embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

In general, methods and systems consistent with the present invention apply laser energy to a quartz workpiece, such as two quartz objects, in order to bring the workpiece to a fusion weldable condition and form a fusion weld between the objects. In order to successfully weld quartz, a careful balance of thermal load at the weldable surface should be maintained in order to create the boundary conditions for the quartz to properly intermingle or fuse on a molecular level and avoid the creation of a cold joint that is improperly fused. Such a system can be used to pierce a quartz object, selectively heat any internal portion of the object using such laser energy in a delicate and almost surgical manner, and then use the laser energy to fusion weld back together the quartz object.

Those skilled in the art will appreciate that use of the terms “quartz”, “quartz glass”, “vitreous quartz”, “vitrified quartz”, “vitreous silica”, and “vitrified silica” are interchangeable regarding embodiments of the present invention. Additionally, those skilled in the art will appreciate that the term “thermally process” means any type of glass processing that requires heating, such as cutting, annealing, or welding.

In more detail, when quartz transitions from its solid or “super-cooled liquid” state to the gaseous state, it evaporates or vaporizes. The temperature range between the liquid and gaseous state is somewhere between about 1900 degrees Celsius (C.) and 1970 degrees C. The precise transition temperature varies slightly because of trace elements in the material and environmental conditions. When heated from its solid or super-cooled state to a still super-cooled but very hot, more mobile state, the quartz becomes tacky or thixotropic. Applicants have found that quartz in this state does not cold flow much faster than at lower elevated temperatures and it does not flow (in the sense of sagging) particularly fast but it does become very sticky.

As the temperature approaches the transition range, the thermal properties of quartz change radically. Below 1900 degrees C., the thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable state, applicants have discovered that it becomes a thermal mirror or a very reflective surface.

The quartz thermal conductivity non-linearly increases with thermal input and increasing temperature. There exists a set of variable boundary layer conditions that thermal input influences. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once, causing abrupt vaporization of the material.

This boundary layer phenomenon is further examined and discussed below. The subsurface layers of the quartz workpiece have, to some depth, a coefficient of absorption which is fixed at “Initial Conditions” (IC) described below in Table 1.

TABLE 1

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | λ |
| Let the density be: | ρ |

As the quartz is heated over a temperature range below 1900 degrees C., k increases but with a shallow slope, and d remains relatively constant and fairly large. However, applicants have found that as the temperature exceeds 1900 degrees C., the slope of k increases at a third-order (cubic) rate until it becomes asymptotic with an increase in thermal conductivity. Simultaneously, the depth of sub-surface penetration d decreases similarly. This causes an increase in the thermal gradient within the quartz object that reduces the bulk thermal conductivity but increases it at the thinning boundary layer on the weldable surface of the object.

As a result, the heat energy is concentrated in the boundary layer at the weldable surface. As this concentration occurs, the coefficient of thermal conductivity increases. These dramatic, non-linear, thermal property changes in the boundary layer create a condition where the energy causes the (finite) weldable surface of the quartz object to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on applying laser energy in order to selectively pierce a quartz object, selectively heat or otherwise thermally process an inner portion of the quartz object and then fusion weld the quartz object back together.

For optimal fusion welding, it is important to determine how much heat is needed to raise the quartz object's temperature to just under the vaporization or sublimation point. As described in related U.S. patent application Ser. No. 09/516,937, the amount of energy (energy from a laser, or other heat source) that is required to heat a quartz object to its thermal balance point (thermal-equilibrium) is preferably determined prior to applying that energy to the quartz object, which is incorporated by reference. The present application focuses on how the energy is applied to one or more quartz objects that make up a quartz workpiece.

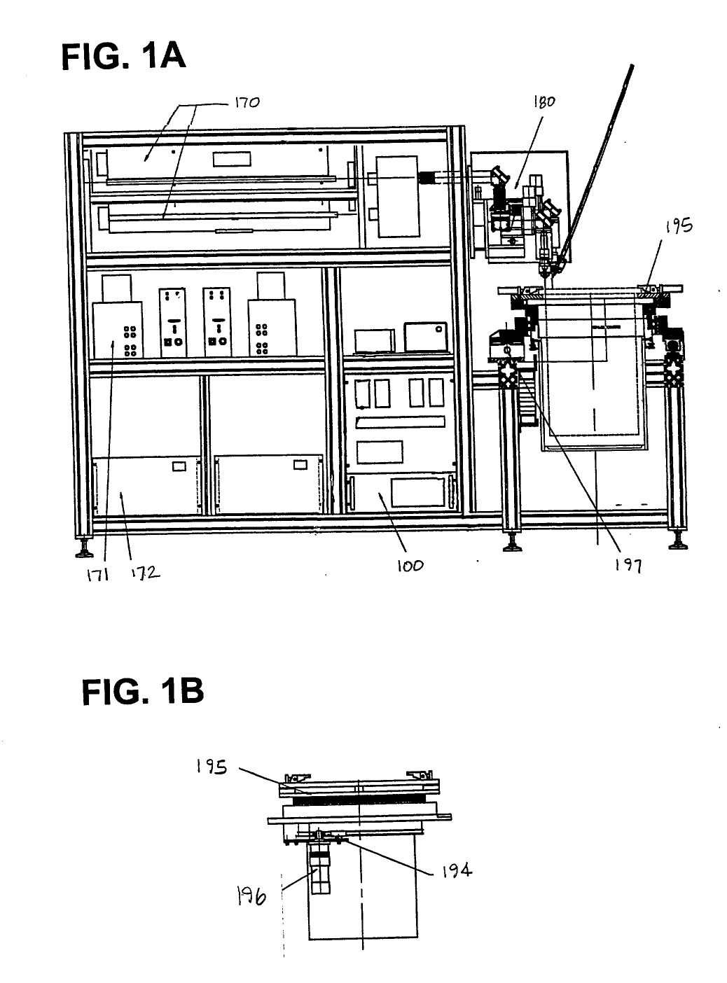

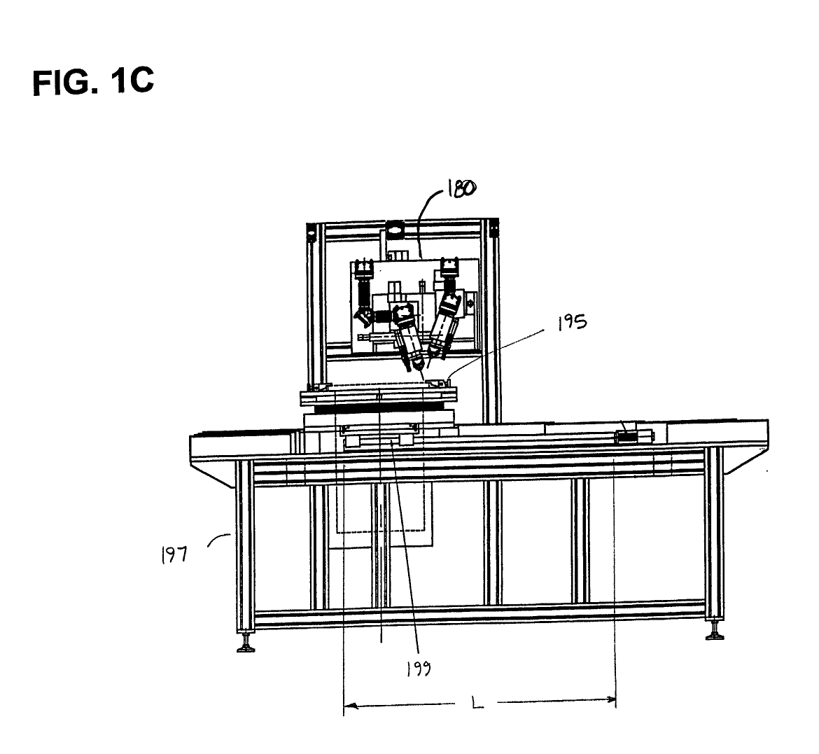

An exemplary quartz fusion welding system is illustrated in FIGS. 1A-C that is suitable for applying laser energy to fusion weld quartz objects consistent with the present invention. FIG. 1A is the front view of such a system. FIG. 1B illustrates the system's movable working surface and FIG. 1C is a side view of the system showing another view of the movable working surface and a movable welding head.

Referring now to FIG. 1A, the exemplary quartz fusion welding system 1 includes a laser energy source 170, a movable welding head 180 (more generally referred to as a reflecting head), a working table 197 having a movable working surface 195, and a computer system 100. While the illustrated system 1 supports the workpiece using working table 197 and movable working surface 195, another embodiment of such a system (not shown) uses a lathe-type support structure for supporting tubular workpieces that can be spun around as laser energy is applied. An embodiment of such an alternative system for supporting and moving the workpiece is described in U.S. patent application Ser. No. ______ entitled “METHOD AND APPARATUS FOR CONCENTRICALLY FORMING AN OPTICAL PREFORM USING LASER ENERGY”, which is commonly owned and hereby incorporated by reference.

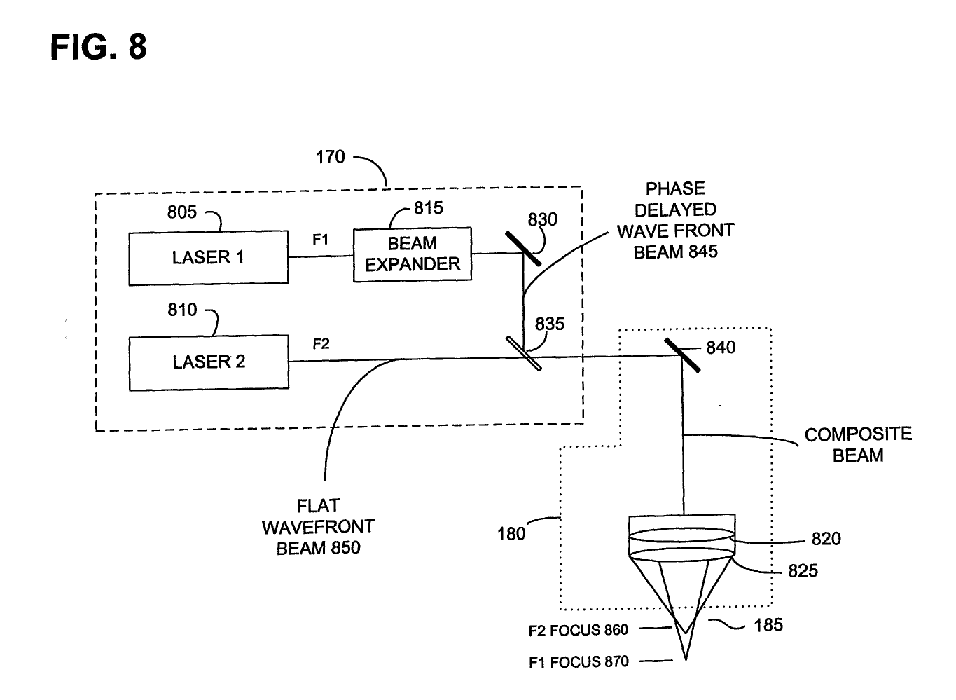

In the illustrated embodiment from FIG. 1A, laser energy source 170 is powered by power supply 171 and cooled using refrigeration system 172. In the exemplary embodiment, laser energy source 170 is one or more sealed Trumpf Laser Model TLF 3000t CO₂ lasers having a predefined wavelength of 10.6 microns. The laser is typically capable of providing 3000 Watts of laser power, has a focal length of 3.75 inches and a focal spot size of 0.2 mm in diameter. Those skilled in the art will appreciate that the lasers can have the same or different wavelengths, such as 355 nm or 3.5 microns, as part of a laser energy source consistent with an embodiment of the present invention. The laser energy source having multiple lasers is discussed in more detail below regarding FIG. 8. Further, those skilled in the art will appreciate that the term “laser” includes systems with terminal optics or may simply be the lasing element per se.

When two quartz objects (not shown) are to be fusion welded, the objects are placed in a pre-weld configuration on movable working surface 195. In general, the pre-weld configuration is a desired orientation of each object relative to each other. More specifically, the pre-weld configuration places a surface of one quartz object proximate to and substantially near an opposing surface of the other quartz object. These two surfaces form a gap or channel between the objects where the laser energy is to be applied. Those skilled in the art will appreciate that the pre-weld configuration for any two quartz objects will vary depending upon the desired joining of the objects.

After placement of the quartz objects into the pre-weld configuration, laser energy source 170 provides energy in the form of a laser beam 175 to movable welding head 180 under the control of computer system 100. Movable welding head 180 receives laser beam 175 and directs its energy in a beam 185 to a welding zone between the two quartz objects in accordance with instructions from computer system 100. While it is important to apply laser energy when fusion welding two quartz objects in an embodiment of the present invention, it is desirable that the system have the ability to selectively direct how and where the laser energy is applied relative to the quartz objects themselves. To provide such an ability, the laser energy is applied in a selectable vector (an orientation and magnitude) relative to the quartz objects being fusion welded.

Selecting or changing the vector can be accomplished by moving the laser energy relative to a fixed object or moving the object to be welded relative to a fixed source of laser energy. In the exemplary embodiment, it is preferably accomplished by moving both the quartz objects being welded (by moving and/or rotating the working surface 195 under control of the computer 100) and by moving the vector from which the laser energy is applied (using actuators to move angled reflection joints within movable welding head 180). In this manner, the system provides an extraordinary degree of freedom by which laser energy can be selectively applied to the quartz object(s).

FIGS. 1B and 1C are diagrams illustrating views of the exemplary working table 197. Referring now to FIG. 1B, a portion of working table 197 is shown having movable working surface 195 that is rotatable. The working surface 195 rotates in response to commands or signals from computer 100 to rotational actuator 196 (typically implemented as a DC servo actuator). A timing belt 194 connects the output of the DC motor within rotational actuator 196 to the working surface 195. Thus, working surface 195 rotates the configuration of quartz objects being welded that are supported on the working surface 195 of table 197. Furthermore, table 197 includes a linear actuator 199 to provide linear movement (also called translation) along a length (preferably considered an x-axis) of table 197 as shown in FIG. 1C. FIG. 1C illustrates a side view of table 197. The linear actuator 199 preferably moves the working surface 195 (and its rotational actuators and controls) along length L so that the quartz objects being fusion welded are moved relative to movable welding head 180. Thus, working surface 195 is movable in a linear and rotational sense to selectively position the quartz object(s) relative to the movable welding head 180.

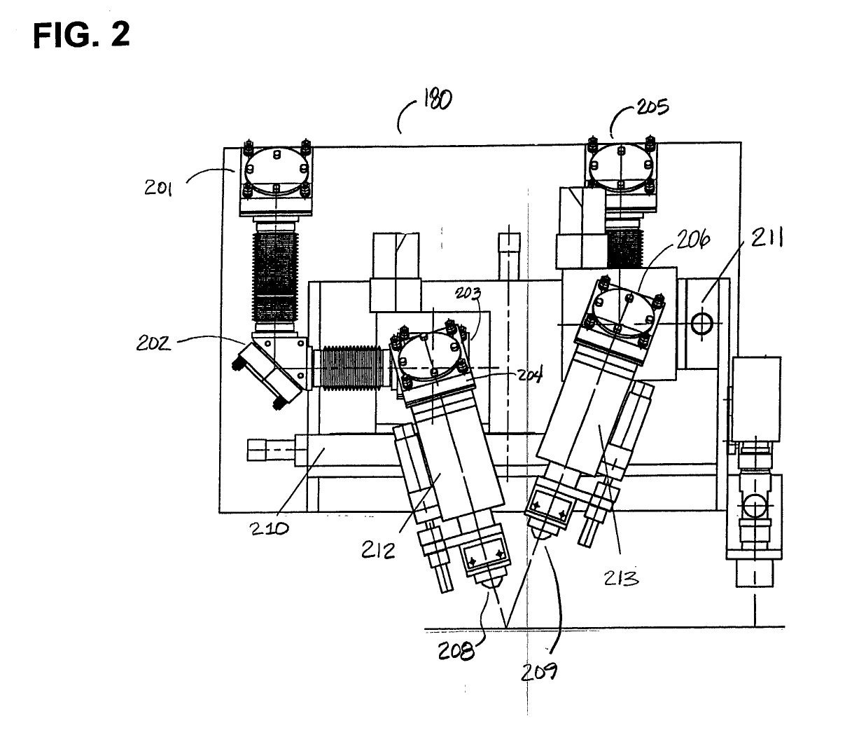

FIG. 2 is a diagram illustrating an exemplary movable welding head used to direct laser energy consistent with an embodiment of the present invention. Referring now to FIG. 2, movable welding head 180 (commonly referred to as a reflective head) is generally a conduit for directing the laser energy from laser energy source 170 to the welding zone between the quartz objects being welded. In the exemplary embodiment, movable welding head 180 (more generally called a movable head) directs laser beams using angled reflective surfaces (e.g., mirrors or other types of reflectors) within elbows of a re-configurable arrangement of angled reflection joints. Furthermore, in the exemplary embodiment and as discussed with regard to FIG. 8 where laser energy source 170 includes two lasers, the first laser projects a beam that is directed through joint 201, through joint 202, through joint 203, and finally through joint 204 before exiting welding head 180 at output 208. Similarly, the second laser projects another beam of laser energy that is directed through another series of angled reflection joints, namely joints 205, 206, and a joint not shown which is directly behind joint 206, before exiting welding head 180 at output 209. Those skilled in the art will appreciate that the alignment of the directed laser energy depends upon the orientation of each joint and its relative position to the other joints.

When using two lasers, it is further contemplated that one of them may be used as a pre-heating laser while the other is used as a welding laser. For example, one of the lasers from laser energy source 170 may provide a pre-heating laser beam through output 208 while the other laser may provide a welding laser beam through output 209.

In the exemplary embodiment, welding head 180 is movable in relation to the source of laser energy 170. This allows positioning of the welding head 180 to selectively alter where the laser energy is to be applied while using a fixed or stationary source of laser energy. In more detail, welding head 180 includes a series of actuators capable of moving the angled reflection joints relative to each other. For example, welding head 180 includes an x-axis actuator 210 and a y-axis actuator 211. These actuators permit movement of the laser beams directed out of laser outputs 208, 209 in an x- and y-direction, respectively. The z-axis actuator (not shown) is located on the back of welding head 180 and operates similar to actuators 210, 211 in that it permits movement of the laser beams directed out of laser outputs 208, 209 in a z-direction (e.g., up and down). The x-axis actuator 210, y-axis actuator 211, and z-axis actuator (not shown) are preferably implemented using an electronically controllable crossed roller slide having a DC motor and an encoder for sensing the movement.

In the embodiment where there are two lasers as the laser energy source, welding head 180 may also include a z1-axis actuator 212 and a z2-axis actuator 213. These actuators 212, 213 move the outputs 208, 209 relative to each other and facilitate focusing the beams. The z1-axis actuator 212 and the z2-axis actuator 213 are preferably implemented as electronically controllable linear motorized slides. Such slides also have DC motors for positioning and encoders for sensing position.

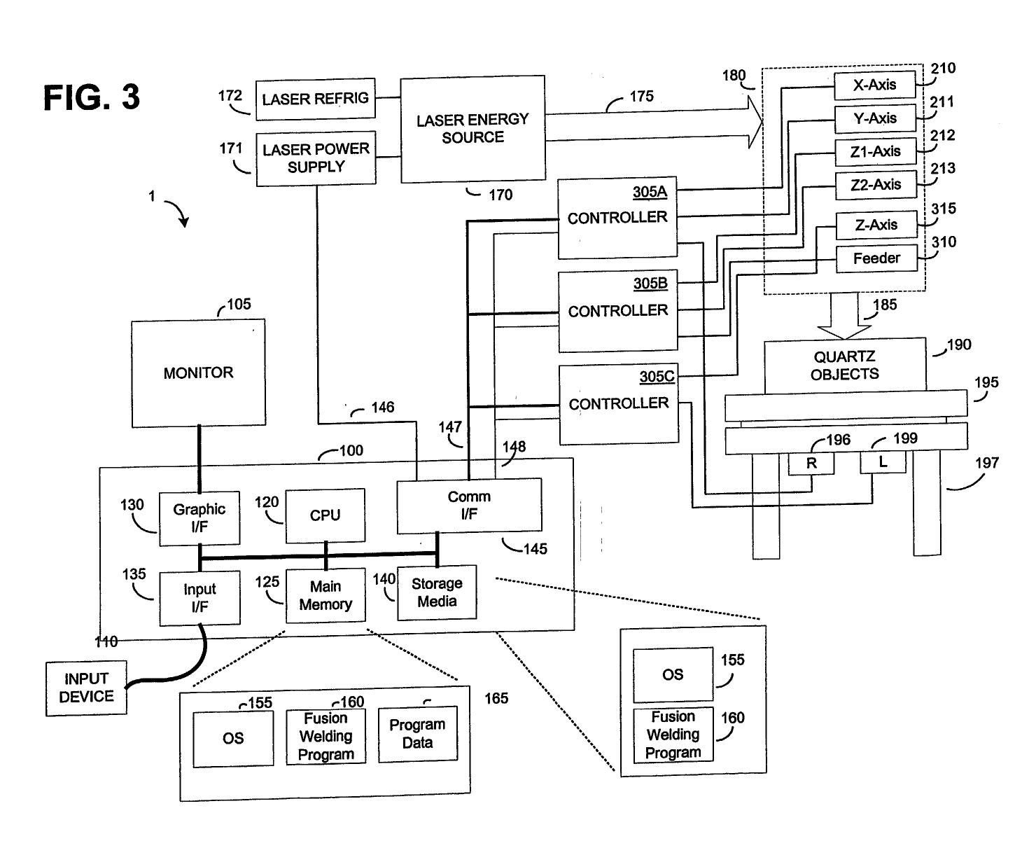

Looking at the exemplary quartz laser fusion welding system 1 in more detail, FIG. 3 is a functional block diagram illustrating components within the exemplary quartz laser fusion welding system consistent with an embodiment of the present invention. Referring now to FIG. 3, computer system 100 sets up and controls laser energy source 170, movable welding head 180, and movable working surface 195 in a precise and coordinated manner during fusion welding of the quartz objects on working surface 195. Computer system 100 typically turns on laser energy source 170 for discrete periods of time. Computer system 100 also controls the positioning of movable welding head 180 and movable working surface 195 relative to the quartz objects being welded so that surfaces on the objects can be easily fusion welded in an automated fashion. As discussed and shown in FIGS. 1B and 1C, movable working surface 195 typically includes actuators allowing it to move along a longitudinal axis (preferably the x-axis) as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125). Computer-readable storage media 140 is preferably implemented as a hard disk drive that maintains files, such as operating system 155 and fusion welding program 160, in secondary storage separate from main memory 125. One skilled in the art will appreciate that other computer-readable media may include secondary storage devices (e.g., floppy disks, optical disks, and CD-ROM); a carrier wave received from a data network (such as the global Internet); or other forms of ROM or RAM.

Graphics interface 130, preferably implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 1 to facilitate communication with and control over those other parts. Communication interface 145 includes a connection 146 (preferably using a conventional I/O controller card) to laser energy source 170 used to setup and control laser energy source 170. In the exemplary embodiment, this connection 146 is to laser power supply 171. Those skilled in the art will recognize other ways in which to connect computer system 100 with other parts of fusion welding system 1, such as through conventional IEEE-488 or GPIB instrumentation connections.

In the exemplary embodiment of the present invention, communication interface 145 also includes an Ethernet network interface 147 and an RS-232 interface 148 for connecting to hardware that implement control systems within movable welding head 180 and movable working surface 195. The hardware implementing such control systems includes controllers 305A, 305B, and 305C. Each controller 305A-C (preferably implemented using Parker 6K4 Controllers) is controlled by computer system 100 via the RS-232 connection and the Ethernet network connection. Communication with the control system hardware through the Ethernet network interface 147 uses conventional TCP/IP protocol. Communication with the control system hardware using the RS-232 interface 148 is typically for troubleshooting and setup.

Looking at the hardware in more detail, controllers 305A-305C control the actuators necessary to selectively apply the laser energy to a surface of a quartz object on the working surface 195 of the table 197. Specifically, controller 305A is configured to provide drive signals to x-axis actuator 210, y-axis actuator 211, and rotational (“R”) actuator 196. Controller 305B is typically configured to provide drive signals to z1-axis actuator 212, z2-axis actuator 213, and a fill rod feeder (“Feeder”) actuator 310 attached to the movable welding head 180. Similarly, controller 305C is configured to provide drive signals to the z-axis actuator 315 and linear (“L”) actuator 199 for linear movement of the working surface 195 of table 197.

Each of the drive signals are preferably amplified by amplifiers (not shown) before sending the signals to control a motor (not shown) within these actuators. Each of the actuators also preferably includes an encoder that provides an encoder signal that is read by controllers 305A-C.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Fusion Welding Process

In the context of the above described system, fusion welding program 160 causes a specific amount of laser energy to be applied to the quartz objects that are in the pre-weld configuration on table 197 in a controlled manner. This is typically accomplished by manipulating the movable welding head 180 and movable working surface 195. The laser energy is advantageously and uniformly applied to the object surfaces being fusion welded.

As part of setting up to fusion weld two quartz objects together, the quartz objects are placed in their pre-weld configuration and soaked at an initial preheating temperature to help avoid rapid changes in temperature that may induce stress cracks within the resulting fusion weld. In the exemplary embodiment, the preheating temperature is typically between 500 and 700 degrees C. and is preferably applied with a laser. Other embodiments may include no preheating or may involve applying energy for such preheating using the beam of laser energy itself or energy from other heat sources, such as a hydrogen-oxygen flame.

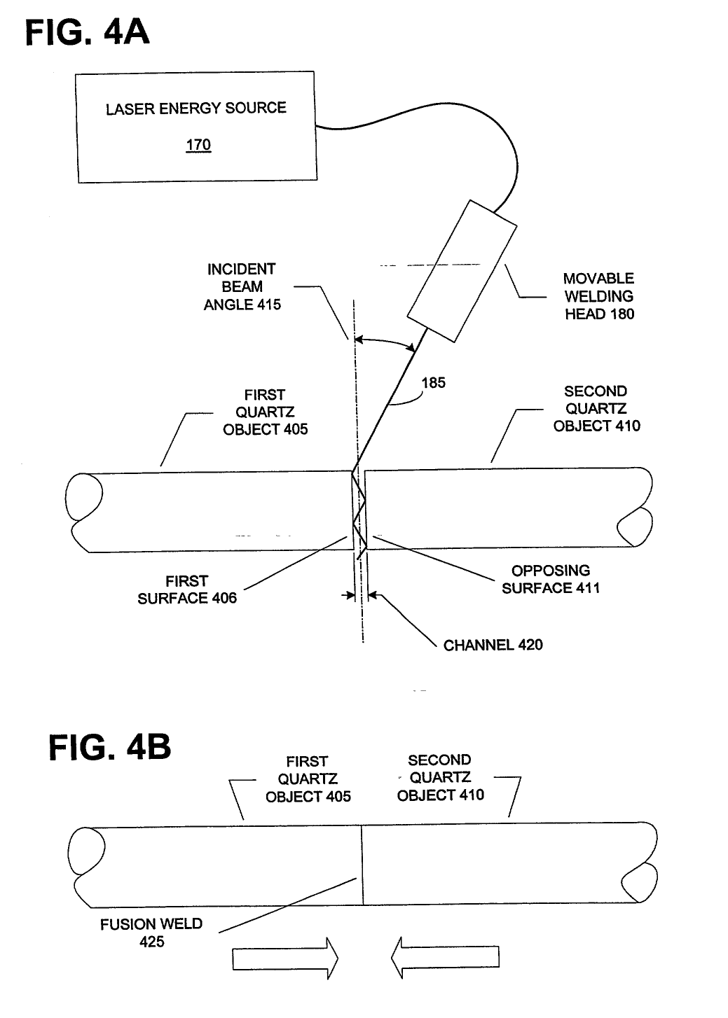

Once preheated, fusion welding program 160 determines how much energy is needed to bring the surfaces of the quartz objects to the desired fusion weldable condition without vaporizing quartz material. Quartz fusion welding system 1 then aligns the source of laser energy by positioning the movable welding head 180 to provide laser beam 185 to a welding zone between the objects being welded. FIGS. 4A and 4B are diagrams illustrating a welding zone between exemplary quartz objects being laser fusion welded consistent with an embodiment of the present invention. Referring now to FIG. 4A, a first quartz object 405 is disposed on movable working surface 195 next to a second quartz object 410 after being preheated. For clarity, the first quartz object 405 and the second quartz object 410 are illustrated as stock quartz rods that have end surfaces 406 and 411, respectively, that are to be fusion welded together. When placing the first quartz object 405 in a pre-weld configuration with the second quartz object 410 before preheating, surface 406 on the first object 405 is placed proximate to and substantially near opposing surface 411 on the second object 410. In this configuration, the end surfaces 406, 411 define a gap or channel 420 between the objects.

After preheating, laser energy source 170 generates laser energy in the form of laser beam 185 that is directed to the welding zone between the objects. Movable welding head 180 operates to align the energy and direct laser beam 185 to end surface 406 of the first object 405. This is typically accomplished by focusing the laser beam at an incident beam angle 415 of 0 to 10 degrees (this may vary depending on the type, geometry and character of the material being processed) from the centerline of the channel. While the exemplary environment typically uses a 0 to 10 degree incident beam angle when launching laser beam 185 into channel 420, those skilled in the art will realize that there are many cases where different geometries of materials may require a different angle of incidence for the laser beam as it is reflected and distributed along the channel 420. For example, if the first quartz object 405 is a rod or cylindrical object that is being fusion welded to a planar second quartz object (not shown), then the incident beam angle may be from 0 to 45 degrees above the planar surface. However, under certain configurations of the material being processed, the angle may vary within a range of values between 0-90 degrees.

As surface 406 absorbs the incident laser energy from laser beam 185 and the surface is increasingly heated, the surface 406 becomes shiny and reflective. In other words, as the surface 406 approaches a fusion weldable condition, the quartz surface 406 reaches a reflective state. In this reflective state, surface 406 bounces or transfers the energy of the laser beam 185 to opposing surface 411. As a result, opposing surface 411 also reaches the reflective state and laser beam 185 is repeatedly reflected down the length of channel 420 heating surfaces 406 and 411 to a substantially uniform or even distribution. This advantageously allows for precise and substantially even heating of surfaces deep within channel 420. Once the surfaces to be welded reach the reflective state and distribute the heat, the surfaces reach a fusion weldable condition so that the surfaces will molecularly fuse together to form a fusion weld.

FIG. 4B is a diagram illustrating the first object 405 after it is fusion welded to the second object 410. The reflected laser energy has heated both end surfaces to reach a fusion weldable condition and then both objects were joined together in a fusion weld 425 where the molecules from the first object 405 become intermingled with the molecules of the second object 410. Those skilled in the art will appreciate that causing the objects to join and then fuse may be due to gravity or due to an applied compressive force.

Additionally, those skilled in the art will appreciate that it is possible to use a glass fill rod to fill in channel 420 and complete the fusion weld. Essentially, the fill rod is fed into the channel as the surfaces in the channel are heated.

While fusion weld 425 is illustrated as a visible line in FIG. 4B, those skilled in the art will also appreciate that the resulting fusion welded quartz will be a singular object with no visible seam, crack or demarcation to show the weld.

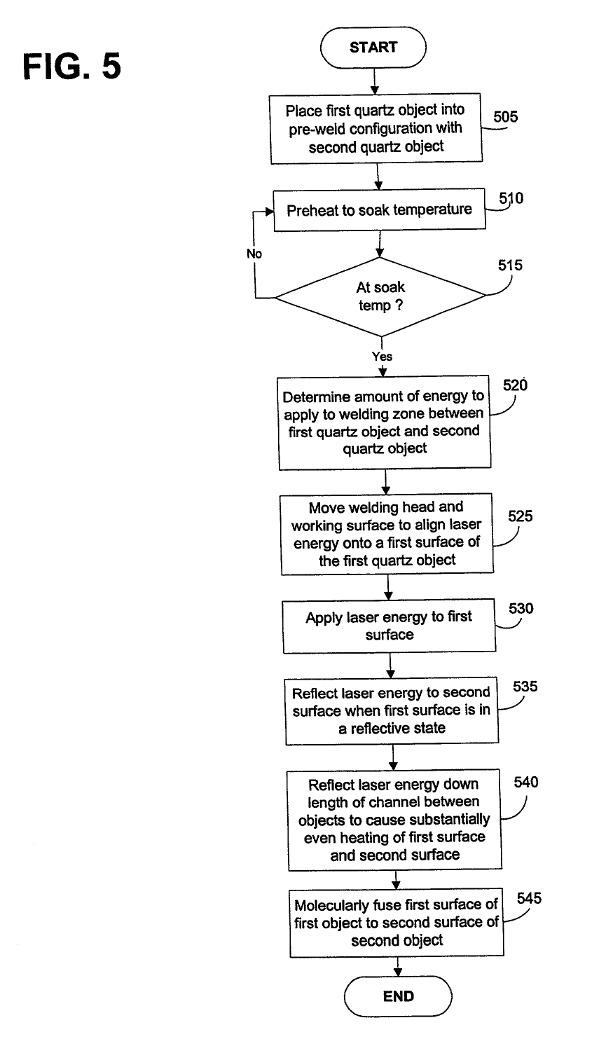

In the context of the above description and information, further details on steps of an exemplary method consistent with the present invention for fusion welding a first quartz object to a second quartz object will now be explained with reference to the flowchart of FIG. 5. Referring now to FIG. 5, the method 500 begins at step 505 where a first quartz object is placed in a pre-weld configuration next to a second quartz object. The exact configuration depends upon which of their respective surfaces are to be fusion welded together. In the exemplary embodiment, the first object is placed proximate to and substantially near the second object so that a surface on the first object and an opposing surface on the second object form a narrow gap or channel.

At step 510, the configuration of quartz objects (also referred to as a quartz workpiece) is preheated to a predetermined soak or preheating temperature. In the exemplary embodiment, the preheating temperature is typically between 500 and 700 degrees C. and is preferably applied with a laser. Depending upon the dimensions of the quartz objects, the dimensions of the surfaces to be fusion welded, and the power of the laser, the time it takes to reach the soaking temperature will vary. In the exemplary embodiment, the laser is used to preheat the area immediately next to each side of the weld line or cutting line path to include the faces of the channel as much as possible. This area is roughly analogous to the “heat affected zone” on a conventionally welded metal body. This area can also be characterized as the margin of the weld channel.

At step 515, if the configuration of quartz objects has reached the soaking temperature, then step 515 will proceed directly to step 520. Otherwise, step 515 will continue to preheat at step 510.

At step 520, an amount of heat is determined that is needed to apply to the welding zone between the first and second object. In the exemplary embodiment, this determination is preferably accomplished in accordance with steps and methods described in U.S. patent application Ser. No. 09/516,937.

At step 525, the parts of the welding system are aligned and moved (such as the welding head and/or the working surface having the quartz objects) so that laser energy can be provided to a first surface of the first object. In the exemplary embodiment, the laser energy is generated by two laser beams that are directed and focused upon the first surface by movable welding head 180 and movable working surface 195.

At step 530, the laser energy is applied to the first surface on the first object. As the first surface (or at least a portion of the first surface) begins to heat up and reach an energy reflective or shiny state, the laser energy is reflected to a second surface on the second object in step 535. Upon reflecting off the first surface to the second surface, the second surface (or at least a portion of the second surface) is heated to the reflective state. At step 540, reflections of the laser energy are bounced down the channel between the first and second surfaces. This causes substantially even heating of the rest of the first and second surfaces to a fusion weldable condition. Once heated in this fashion, the first surface and the second surface can molecularly fuse to each other at step 545 forming a fusion weld between the quartz objects. Typically, this is accomplished by causing the objects to contact each other when in the desired fusion weldable condition.

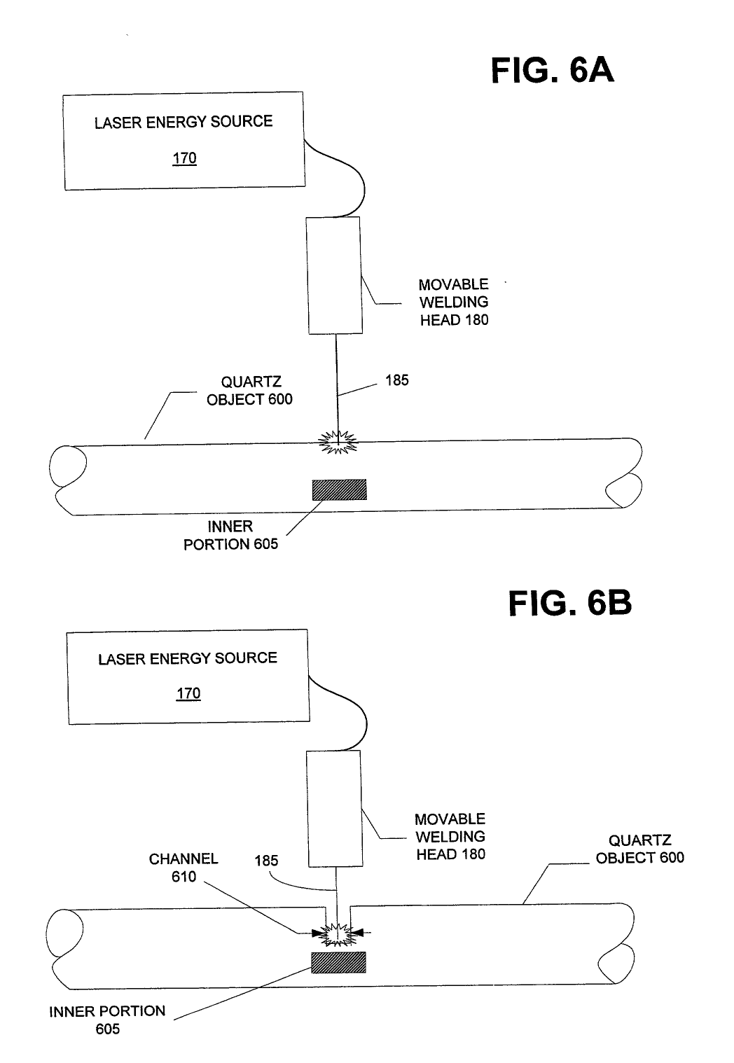

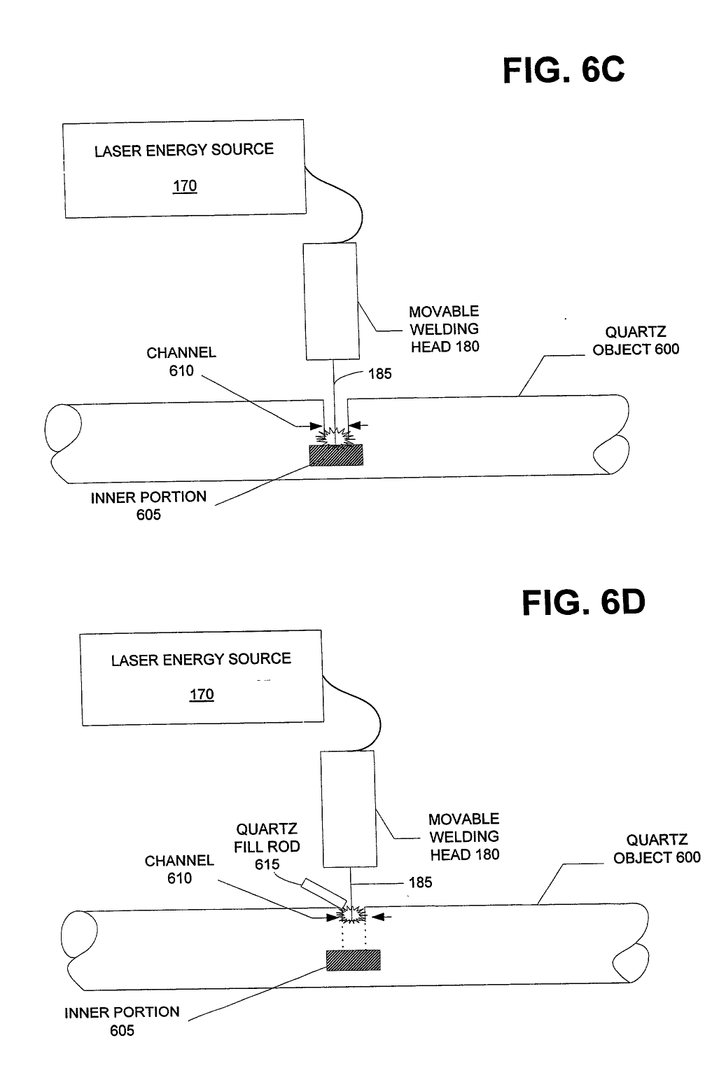

In another embodiment, methods and systems are used to apply laser energy to pierce a quartz object, selectively heat an inner portion of the quartz object and then apply the appropriate amount of laser energy to close or, preferably, fusion weld the quartz object back together. FIGS. 6A-6D illustrate how a laser beam can be used to thermally process an inner portion of a quartz object consistent with an embodiment of the present invention.

Referring now to FIG. 6A, an exemplary embodiment is shown where laser energy source 170 generates one or more beams 185 of laser energy. The beam 185 is directed to quartz object 600 via movable welding head 180. As beam 185 is applied to the surface of quartz object 600, the beam penetrates and pierces the surface of the object 600. In the exemplary embodiment, it is preferable to set the initial energy level of the beam high enough to cut into the quartz object.

Referring now to FIG. 6B, a channel 610 is illustrated being cut into the body of the quartz object 600 as the beam 185 continues to be applied. When the depth of the channel 610 reaches the desired internal part of the quartz object, such as inner portion 605, the beam 185 can be advantageously used to efficiently heat or otherwise thermally process that particular part or portion within the quartz object, as shown in FIG. 6C. Typically, this is accomplished at a laser beam energy level that is lower than that used for cutting into the quartz object.

For example, if a cold joint exists at inner portion 605, conventional procedures would call for placing the entire object 600 into a standard annealing oven (not shown) in order to fix the imperfection or defect within the object 600. However, in accordance with the exemplary embodiment of the present invention, beam 185 may be selectively and surgically applied at a desired heating energy level to achieve the desired thermal heating or other type of thermal processing of the inner portion 605.

When the heating or any other thermal processing of the inner portion 605 is complete, beam 185 can be used to essentially “zip up” or close the quartz object 605, as shown in FIG. 6D. Referring now to FIG. 6D, the energy level of beam 185 is typically altered to another level when closing channel 610 using the beam 185. In the exemplary embodiment, the energy level of beam 185 is set to the appropriate or welding level where the interior walls of channel 610 can be fusion welded together. This may involve bouncing the beam 185 down the channel as discussed in more detail above regarding FIG. 4A. Furthermore, in some instances, a fill rod 615 of quartz filler is provided in the channel 610 in order to provide extra quartz filler material to complete the fusion welding or closing of the channel 610. In such a situation, the quartz filler material and the interior walls of channel 610 are heated to a desired fusion weldable state whereby the filler material and the quartz object become fusion welded together.

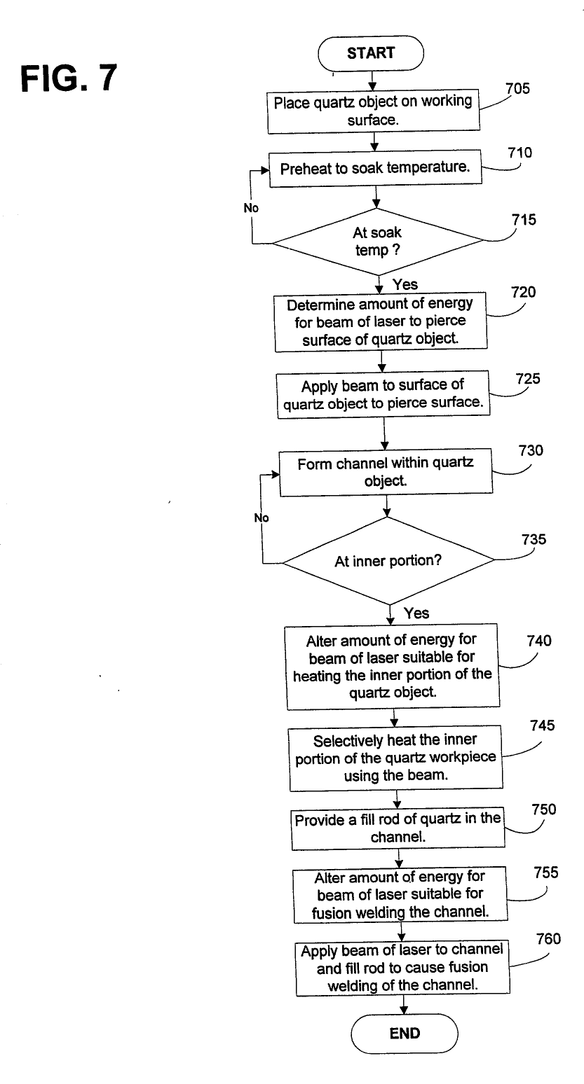

FIG. 7 is a flow chart illustrating typical steps for thermally processing a quartz object using laser energy consistent with an embodiment of the present invention. Referring now to FIG. 7, method 700 begins at step 705 where the quartz object is placed on a working surface. In the exemplary embodiment, quartz object 600 may be placed on working surface 195 in preparation for processing the object.

At step 710, the object is typically preheated to a predetermined soak or preheating temperature. In the exemplary embodiment, the preheating temperature is typically between 500 and 700 degrees C. Further, preheating is preferably accomplished by applying the beam of laser energy to the object at an energy level lower than that used to fusion weld the quartz object. Other embodiments use an annealing oven (not shown) or other type of heating process to bring the object to the desired preheating temperature.

If the object is at the predetermined soak or preheating temperature at step 715, then step 715 proceeds directly to step 720. Otherwise, additional preheating is required and step 715 proceeds back to step 710.

At step 720, the object has preferably been brought to its predetermined soak temperature and is ready to be further processed. Thus, the amount of energy needed for the laser beam to penetrate or pierce the surface of the quartz object is determined in this step. Typically, this amount of energy is an amount that is slightly above the vaporization or sublimation point so that the beam may cut through the quartz material that makes up the object.

At step 725, the laser beam is applied to the surface of the quartz object to pierce the surface of the object. As the laser beam is applied, it is preferable to select or change the vector of the laser energy relative to the quartz object. In this manner, applying the laser beam at the piercing energy level will form a channel, such as channel 610 illustrated in FIG. 6B, within the quartz object at step 730. Those skilled in the art will appreciate that while it is preferable that the channel is a planar-type of penetration of the object's surface, it is envisioned that the channel may be an opening of variable geometry caused by altering the beam's vector as it is applied to the object. For example, the channel may be cone-shaped or cylindrical.

At step 735, if the depth of the channel is at or proximate to an inner portion of the object, then step 735 proceeds directly to step 740. Otherwise, step 735 proceeds back to step 730 for additional application of the laser beam within the channel.

In the exemplary embodiment, beam 185 is used to essentially cut open channel 610 down to inner portion 605 of object 600, as shown in FIG. 6C. The inner portion may be any point, two-dimensional feature or even three-dimensional area within the object. An example of such an inner portion is a cold joint weld. In the past, a cold welding joint required an undesirable time-intensive annealing process. However, the inner cold weld joint can be quickly and easily accessed, processed thermally, and then the quartz object can be welded back together again using an embodiment of the present invention.

At step 740, the amount of energy provided by the laser beam is altered to halt further penetration of the object but to allow heating of the object. Typically, this is accomplished by altering the energy level of the laser beam or beams coming out of the laser energy source. Alternatively, this may be accomplished by modulating or selectively applying the beam so that the average (as opposed to instantaneous) energy level applied is reduced. Further, yet another embodiment alters the focal characteristics of the beam to change the amount of energy provide, thus halting further penetration of the object but still allowing heating of the object.

Next, the beam is used to selectively heat the inner portion and perhaps additional area surrounding the particular inner portion of the quartz object at step 745. Selective heating may be accomplished in a variety of manners, such as applying the beam at a given energy level for a predetermined amount of time, moving the beam over the inner portion for a determined period, or modulating the intensity of the beam. As explained in more detail below with regard to FIG. 8, selective heating may also be accomplished by changing the focal characteristics of the laser beam.

In one embodiment, the inner portion may be an area within the object having dopant material, such as a metal halide. In such an example, the beam may be selectively applied to the inner portion to induce thermal diffusion of the particular dopant within the inner portion or next to the inner portion, thus creating a desirably doped section of the object. This may be particularly useful when processing optical preforms used to make high quality optical fibers. In addition, lasers of different wavelengths, energy levels and focal lengths can be used to selectively heat or cause a reaction with the dopant material or other reactant materials or gases.

In another embodiment, the beam is selectively applied to thermally process the inner portion (e.g., form a fusion weld at the inner portion) in order to resolve or fix an imperfection in the quartz object. As previously mentioned, two quartz objects may be joined together to form a single object. However, if the joint is not a complete fusion weld, the object is flawed and must be fixed. Using the beam to fix such a flaw or imperfection instead of placing the object into a standard annealing oven advantageously saves a great deal of time and money when processing quartz.

At this point where the inner portion has been thermally processed, the object is normally re-sealed or “zipped” back up to complete the desired processing of the quartz object. Sometimes, this may be accomplished without the use of filler material and method 700 proceeds past step 750 to step 755. However, if the channel is too wide and the interior walls of the channel are not easily pressed back together to form a clear fusion weld, the closing procedure may require filler material, such as a fill rod of quartz 615, which is provided at step 750.

At step 755, the amount of energy applied in the laser beam is again altered. In the exemplary embodiment, this next level of the energy is the amount necessary or suitable for fusion welding of the channel. Thus, the energy to be applied to the object via the laser beam is carefully determined so that laser energy is applied to both surfaces of the channel to form a fusion weld of the surfaces and does not further penetrate the object. Thus, the determined amount of laser energy is applied to the channel and preferably to the fill rod to cause fusion welding of the channel at step 760, which completes method 700.

In the exemplary embodiment, the laser beam can be one or more laser beams. This is often useful and desired when the area to be heated is relative thick and there is a need to create a lengthy heating zone. With multiple laser beams, selective focusing of the laser beams can also alter how the energy is applied to the object to achieve such a lengthy heating zone. As explained in more detail below with regard to FIG. 8, selective heating may also be accomplished by changing the focal characteristics of the laser beam.

Referring now to FIG. 8, details within laser energy source 170 and movable welding head 180 are further illustrated to show how multiple laser beams can be focused. In this example, laser energy source 170 comprises a first laser (Laser1) 805 and a second laser (Laser2) 810. Laser1 805 and Laser2 810 are preferably Gaussian lasers and may have the same or different wavelengths, energy levels, and focal points.

In the exemplary embodiment, Laser1 805 provides a laser beam F1 to a beam expander 815, which changes the phase of the F1 wave front. This creates a phase-delayed wave front 845 that is reflected off reflector 830. Combiner/reflector 835 then joins phase-delayed wave front 845 with a flat wave front beam 850 (also called the F2 wave front), which is provided by Laser2 to produce an integrated or composite laser beam. In this manner, Laser1 805 and Laser2 810 can be combined or bundled together coaxially or collaterally to target specific zones on or within the quartz through their respective focal characteristics precipitating reactions from or with chemicals, dopant materials, or other specifices that affect the physical, chemical or optical characteristics of the quartz.

The composite laser beam is preferably provided to the moveable welding head, reflected through a series of reflectors 840 onto lenses 820, 825. The ability to alter or change optical characteristics of lens 820 and lens 825 (such as their respective focal lengths) provides the ability to create a high energy concentration field (also called the heating zone) between the F1 focus point 870 and the F2 focus point 860. Those skilled in the art will appreciate that superposition of multiple foci will produce a relatively lengthy and high energy zone, which can be used to selectively heat quartz within that area as the composite beam is moved relative to the quartz. The ability to use lasers having independently selectable wavelengths, energy levels, and focal points provides additional flexibility to the composite beam to facilitate enhanced processing of the quartz and/or other dopant materials heated by the composite beam.

Those skilled in the art will appreciate that embodiments consistent with the present invention may be implemented in a variety of technologies and that the foregoing description of an implementation of the invention has been presented for purposes of illustration and description. It is not exhaustive and does not limit the invention to the precise form disclosed. Modifications and variations are possible in light of the above teachings or may be acquired from practicing of the invention. While the above description encompasses one embodiment of the present invention, the scope of the invention is defined by the claims and their equivalents.

What is claimed is:

1. A method for thermal processing a quartz object, comprising the steps of:
applying a beam of laser energy to the quartz object;
forming a channel within the quartz object from an exterior surface of the quartz object to an inner portion of the quartz object using the beam of laser energy;
thermally processing the inner portion of the quartz object; and
closing the channel using the beam of laser energy.

2. The method of claim 1, wherein the closing step comprises fusion welding the channel back together using the beam of laser energy.

3. The method of claim 1, wherein the applying step comprises applying the beam of laser energy at a first energy level.

4. The method of claim 2, wherein the thermally processing step further comprises applying the beam of laser energy at a second energy level to the inner portion.

5. The method of claim 4, wherein the second energy level is less than the first energy level.

6. The method of claim 1, wherein the thermally processing step further comprises thermally inducing diffusion within the inner portion of the quartz object.

7. The method of claim 6, wherein the thermally inducing step further comprises selectively applying the beam of laser to the inner portion of the quartz object for a predetermined amount of time at a predefined energy level.

8. The method of claim 4, wherein the channel defines at least two interior sides; and
wherein the closing step further comprises applying the beam of laser energy at a third energy level to each of the interior sides of the channel causing the interior sides of the channel to fusion weld together.

9. The method of claim 4, wherein the closing step further comprises providing a fill rod of quartz within the channel as the beam of laser energy is applied causing quartz from the fill rod and the channel to fusion weld together.

10. A method for thermal processing a quartz object, comprising the steps of;
piercing the quartz object with a beam of laser energy; and
thermally processing an inner portion of the quartz object using the beam of laser energy.

11. The method of claim 10 further comprising the step of fusion welding the pierced quartz object together using the beam of laser energy.

12. The method of claim 11, wherein the fusion welding step further comprises applying the beam of laser energy to a fill rod of quartz to cause fusion welding of the pierced quartz object and the quartz from the fill rod.

13. The method of claim 10, wherein the piercing step further comprises applying the beam of laser energy at a first level of energy to a starting point on the quartz object; and
wherein the thermally processing step further comprises applying the beam of laser energy at a second energy level as the beam reaches the inner portion of the quartz object.

14. The method of claim 13, wherein the second energy level is less than the first energy level.

15. The method of claim 10, wherein the thermally processing step further comprises thermally inducing diffusion within the quartz object.

16. The method of claim 15, wherein the thermally inducing step further comprises selectively applying the beam of laser to the inner portion of the quartz object for a predetermined amount of time at a predefined energy level.

17. An apparatus for thermally processing a quartz object, comprising:
a controller; and
a laser energy source in communication with the controller, the laser energy source being capable of applying a beam of laser energy to the quartz object to pierce a surface of the quartz object and thermally processing an inner portion of the quartz object using the beam of laser energy.

18. The apparatus of claim 17, further comprising a movable head in communication with the controller and coupled to receive the beam of laser energy from the laser energy source, the movable head being operative to direct the beam of laser energy onto a surface on the quartz object in response to signals from the controller.

19. The apparatus of claim 18, wherein the movable head is selectively positioned relative to the surface on the quartz object.

20. The apparatus of claim 18, wherein the movable head is selectively positioned relative to the laser energy source and the surface on the quartz object using at least one actuator.

21. The apparatus of claim 18, the controller is further operative to:
cause the laser energy source to provide the beam at a first energy level to the movable head,
cause the reflecting head to be positioned relative to the laser energy source in order to apply the beam onto the surface of the quartz object, and
cause the laser energy source to provide the beam at a second energy level once the beam has pierced the quartz object and is being applied to the inner portion of the quartz object via the movable head.

22. The apparatus of claim 19, wherein the laser energy source is capable of providing the beam of laser energy at a first energy level to the movable head; and
wherein the movable head is operative to apply the beam onto the surface of the quartz object to cause the surface of the quartz object to be pierced.

23. The apparatus of claim 22, wherein the laser energy source is further capable of providing the beam at a second energy level in order to enable thermal processing of the inner portion of the quartz object.
